(19) United States
(12) Patent Application Publication
(10) Pub. No.: US 2015/0272394 A1
(43) Pub. Date: Oct. 1, 2015

(54) BLENDER

(71) Applicant: Tsann Kuen (Zhangzhou) Enterprise Co., Ltd., Zhangzhou (CN)

(72) Inventors: Chieh-Wen LIN, Zhangzhou (CN); Wen-Xia ZHANG, Zhangzhou (CN)

(21) Appl. No.: 14/509,591

(22) Filed: Oct. 8, 2014

(30) Foreign Application Priority Data
Mar. 28, 2014 (CN) 201420147873.0

(51) Int. Cl. A47J 43/046

(52) U.S. Cl. CPC A47J 43/046

(57) ABSTRACT

A blender includes a container, a cap, and a sealing module. The cap covers the container. The sealing module includes a mounting seat, a sealing member, a shaft, a valve, and an accessible member. The mounting seat is mounted movably on the cap. The sealing member is disposed in the container, and mounted to the mounting seat. The shaft extends through and is movable relative to the mounting seat, the cap and the sealing member, and has a lower end mounted co-movably to the valve. The accessible member is mounted on the mounting seat, is connected co-movably to the shaft, and is operable to move the shaft along the vertical axis so as to drive the valve between a release position and an air-tight position.

### CROSS-REFERENCE TO RELATED APPLICATION

This application claims priority to Chinese Application No. 201420147873.0, filed on Mar. 28, 2014.

### FIELD OF THE INVENTION

This invention relates to a blender, more particularly to a blender capable of reducing blending of air into a mixture.

### BACKGROUND OF THE INVENTION

A conventional blender generally includes a container, a rotatable blade disposed in the container for cutting and blending contents such as vegetables and fruits disposed in the container into a mixture, and a cap for covering the container. However, air in the container will be blended into the contents in the container, thus generating bubbles in the mixture during use of the conventional blender. The bubbles would result in oxidation of the mixture and thus adversely affect nutrition of the mixture.

### SUMMARY OF THE INVENTION

Therefore, the object of the present invention is to provide a blender capable of alleviating the above drawbacks of the prior art.

According to this invention, a blender includes a container, a cap, a motor unit, and a sealing module. The container defines a vertical axis and has first and second open ends that are opposite to each other along the vertical axis. The cap is disposed to cover the first open end. The motor unit includes a base seat disposed to seal the second open end, and a blade rotatably mounted on the base seat and extending into the container. The sealing module includes a mounting seat, a sealing member, a shaft, a valve, and an accessible member. The mounting seat is mounted on the cap and is adjustable to move along the vertical axis with respect to the cap. The sealing member is disposed in the container, is mounted to a bottom end of the mounting seat, and defines a receiving space opposite to the mounting seat. The shaft extends through and is movable relative to the mounting seat, the cap and the sealing member along the vertical axis, and has opposite upper and lower ends. The valve is mounted co-movably to the lower end of the shaft. The accessible member is mounted on the mounting seat, is connected co-movably to the upper end of the shaft, and is operable to move the shaft along the vertical axis so as to drive the valve between a release position, where the valve is spaced apart from the sealing member in an axial direction parallel to the vertical axis and the sealing member is radially spaced apart from the container, and an air-tight position, where the valve is received in the receiving space to make the sealing member resiliently deform and abut against the container in an air-tight manner.

### BRIEF DESCRIPTION OF THE DRAWINGS

Other features and advantages of the present invention will become apparent in the following detailed description of the embodiments of the invention, with reference to the accompanying drawings, in which:

FIG. 1 is an exploded perspective view of a first embodiment of a blender according to the present invention;

FIG. 2 is a schematic sectional view of the first embodiment of the blender, illustrating a valve of the blender at a release position;

FIG. 3 is a fragmentary schematic sectional view illustrating an accessible member of the blender mounted rotatably to a mounting seat of the blender;

FIG. 4 is a fragmentary enlarged view of FIG. 2, illustrating a sealing member of the blender being spaced apart from a container of the blender and the valve being spaced apart from the sealing member;

FIG. 5 is a schematic sectional view of the blender, illustrating the valve at an air-tight position;

FIG. 6 is a fragmentary enlarged view of FIG. 5, illustrating the valve being received in the sealing member and the sealing member being resiliently deformed and abutting against the container in an air-tight manner;

FIG. 7 is a schematic perspective view of the accessible member, a clip and a button of the blender;

FIG. 8 is a fragmentary schematic sectional view of the accessible member, the clip and the button;

FIG. 9 is a sectional view of a cap of the blender and the mounting seat, illustrating the mounting seat at an unlocked position and slidable relative to the cap;

FIG. 10 is a sectional view of the cap and the mounting seat, illustrating the mounting seat at a locked position to engage the cap;

FIG. 11 is an exploded perspective view of a second embodiment of the blender;

FIG. 12 is a schematic sectional view of the second embodiment of the blender, illustrating a valve thereof at the release position; and

FIG. 13 is a schematic sectional view of the second embodiment of the blender, illustrating the valve thereof at the air-tight position.

### DETAILED DESCRIPTION OF THE EMBODIMENTS

Before the present invention is described in greater detail, it should be noted that like elements are denoted by the same reference numerals throughout the disclosure.

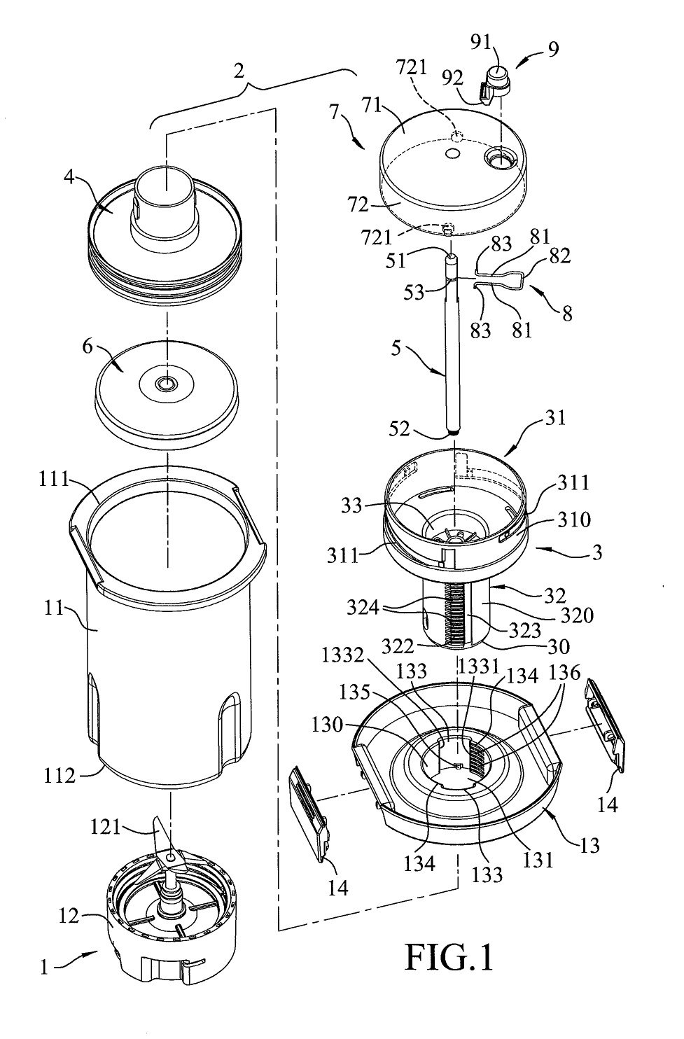

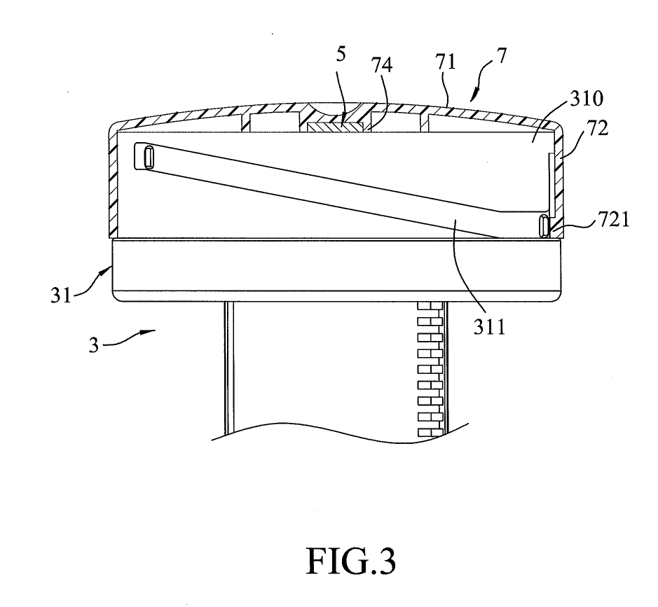

Referring to FIGS. 1 to 6, the first embodiment of the blender according to the present invention includes a motor unit 1, a container 11, a sealing module 2 and a cap 13.

The container 11 is cylindrical, defines a vertical axis (A), and has first and second open ends 111, 112 that are opposite to each other along the vertical axis (A). The cap 13 is disposed to cover the first open end 111, is formed with a through hole 131 extending in an axial direction parallel to the vertical axis (A), and has an inner surface 130 defining the through hole 131. Two fastening members 14 are disposed to fasten the cap 13 to the container 11.

The motor unit 1 includes a base seat 12 disposed to seal the second open end 112, and a blade 121 rotatably mounted on the base seat 12 and extending into the container 11 to cut, blend or grind contents such as vegetables and fruits in the container 11.

The sealing module 2 includes a mounting seat 3, a sealing member 4, a shaft 5, a valve 6 and an accessible member 7.

The mounting seat 3 is mounted on the cap 13, includes a main body 31 and an insertion tube 32, and defines a passage 33 extending through the main body 31 and the insertion tube 32 in the axial direction. The main body 31 is seated on the cap 13. The insertion tube 32 extends from the main body 31 in the axial direction, and extends movably through the through hole 131 of the cap 13.

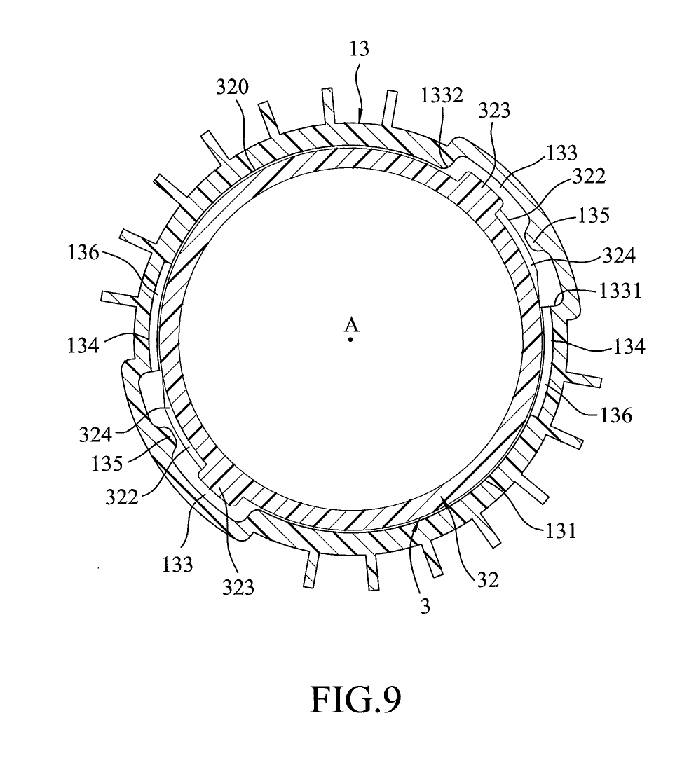

The inner surface 130 of the cap 13 is provided with two first engaging mechanisms 134, two guiding grooves 133, and two protuberances 135 as best shown in FIG. 9. Each of the first engaging mechanisms 134 includes a plurality of furrows 136 that are depressed radially from the inner surface 130 of the cap 13 and that are spaced apart from one another in the axial direction.

The guiding grooves 133 extend in the axial direction, are diametrically opposite to each other with respect to the vertical axis (A), and are depressed radially from the inner surface 130. Each of the guiding grooves 133 is defined by a first terminating end surface 1331 that extends in the axial direction and that is disposed adjacent to a respective one of the first engaging mechanisms 134, and a second terminating end surface 1332 that extends in the axial direction and that is angularly opposite to the first terminating end surface 1331 about the vertical axis (A).

With further reference to FIG. 9, an outer surface 320 of the insertion tube 32 is provided with two second engaging mechanisms 322 and two barrier ridges 323. Each of the second engaging mechanisms 322 includes a plurality of ribs 324 that protrude radially and outwardly from the outer surface 320 of the insertion tube 32, that are spaced apart from one another in the axial direction, and that engage the furrows 136 of a respective one of the first engaging mechanisms 134.

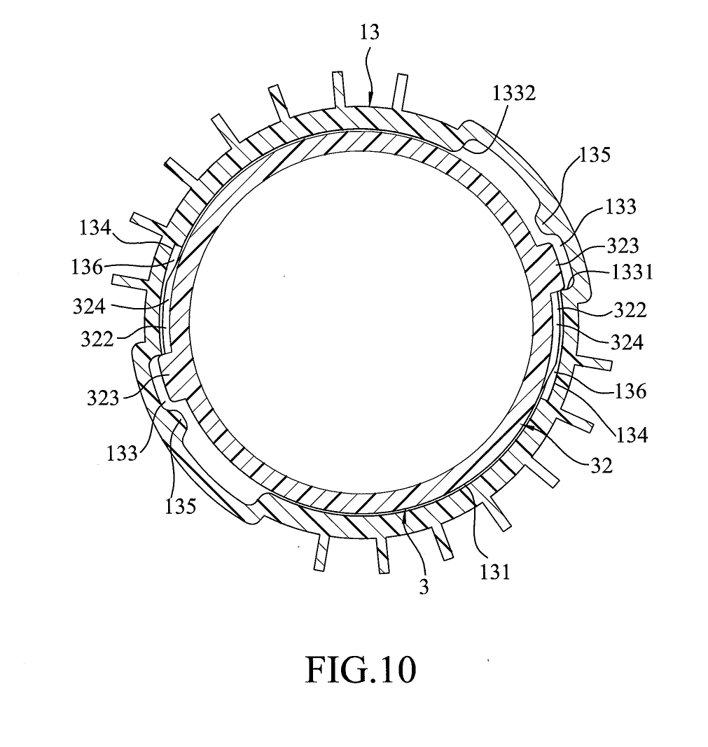

The mounting seat 3 is rotatable about the vertical axis (A) with respect to the cap 13 between an unlocked position and a locked position. As shown in FIG. 9, when the mounting seat 3 is at the unlocked position, the mounting seat 3 is movable along the vertical axis (A) with respect to the cap 13, and the second engaging mechanisms 322 are slidable in the guiding grooves 133, respectively. Turning to FIG. 10, when the mounting seat 3 is at the locked position, the second engaging mechanisms 322 engages the first engaging mechanisms, respectively, so as to maintain the mounting seat 3 at a desired position with respect to the cap 13.

The barrier ridges 323 extend in the axial direction, and protrude radially and outwardly from the outer surface 320. Each of the barrier ridges 323 is disposed adjacent to a respective one of the second engaging mechanisms 322, and abuts against the first and second terminating end surfaces 1311, 1332, which define a respective one of the guiding grooves 133, when the mounting seat 3 is disposed at the locked and unlocked positions, respectively.

Further, each of the protuberances 135 is disposed in a respective one of the guiding grooves 133 between the first and second terminating end surfaces 1331, 1332 thereof and provides a restricting force to a corresponding one of the barrier ridges 323 so as to prevent the mounting seat 3 from rotating between the unlocked and locked positions when an external force is not applied.

Note that a protruding thickness of each of the barrier ridges 325 is larger than that of each of the ribs 324 and a depressed depth of each of the furrows 136, and is smaller than a depressed depth of each of the guiding grooves 133.

By virtue of the abovementioned configurations, the mounting seat 3 is adjustable to move along the vertical axis (A) with respect to the cap 13, and can be positioned with respect to the cap 13 at a desired position.

The sealing member 4 is disposed in the container 11, defines a receiving space 41 opposite to the mounting seat 3, and is made of a resilient material. The sealing member 4 is mounted stably to a bottom end 30 of the insertion tube 32, and is moved together with the insertion tube 32. The sealing member 4 is formed with a plurality of air holes 42 spatially communicating the receiving space 41 with the passage 33.

The shaft 5 extends through the passage 33, and is movable relative to the mounting seat 3, the cap 13 and the sealing member 4 along the vertical axis (A), and has opposite upper and lower ends 51, 52.

The valve 6 is mounted co-movably to the lower end 52 of the shaft 5.

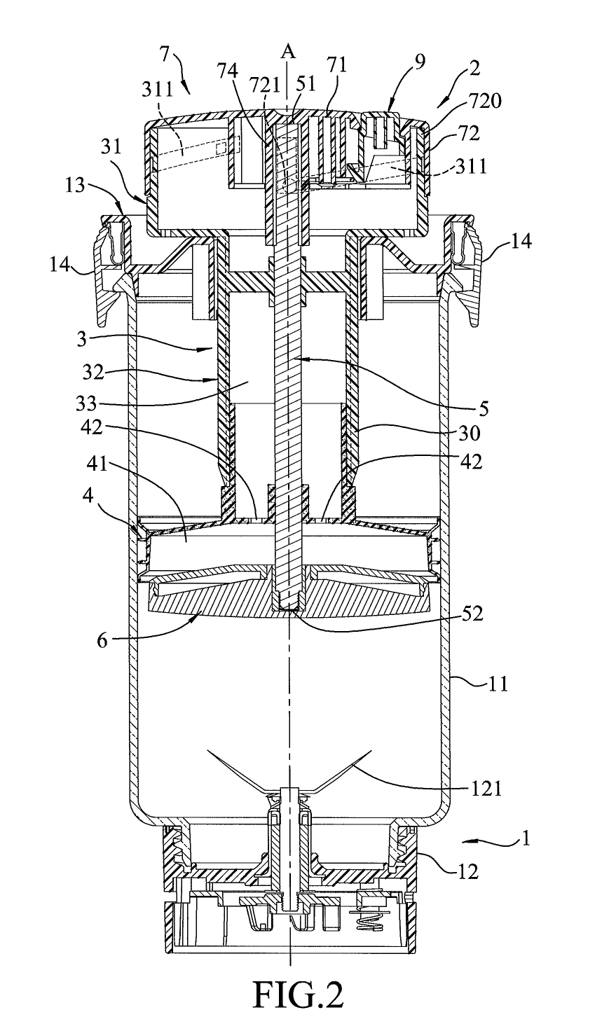

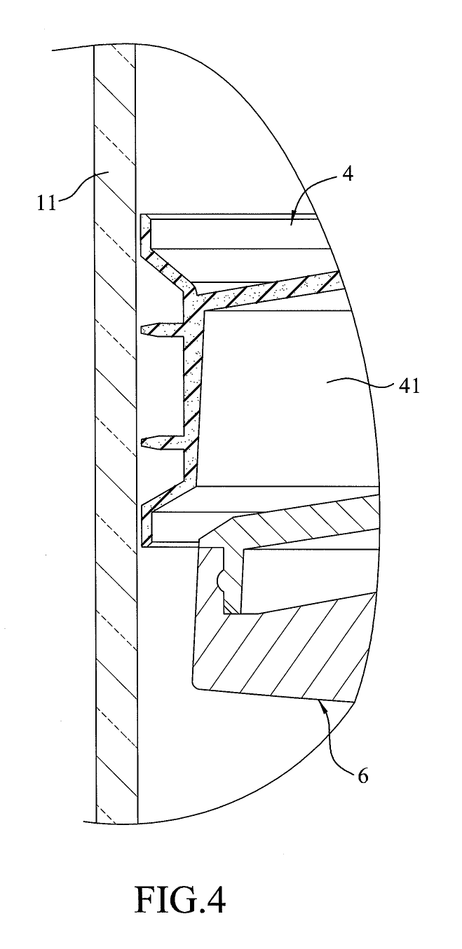

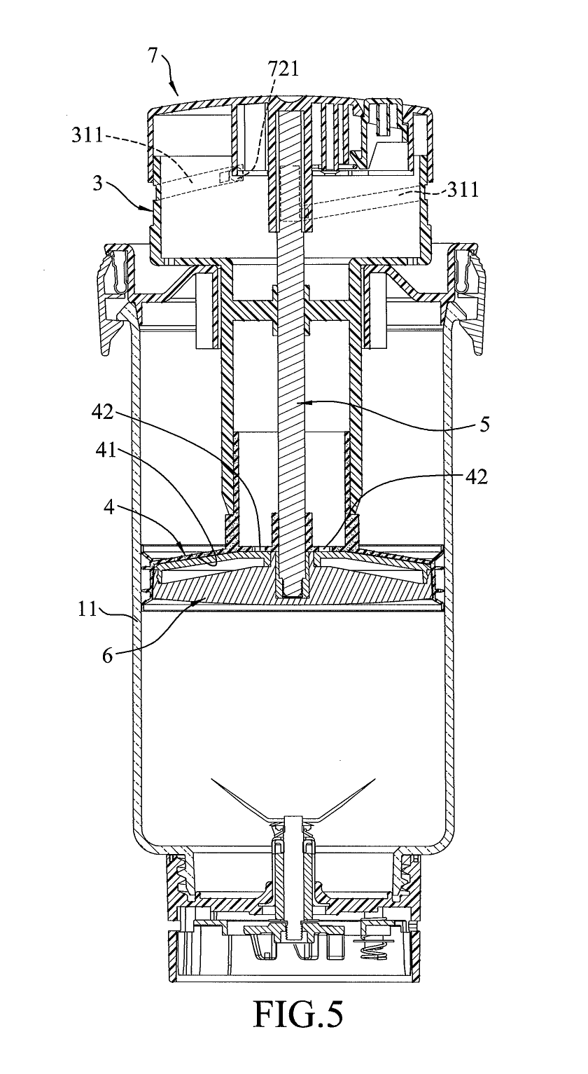

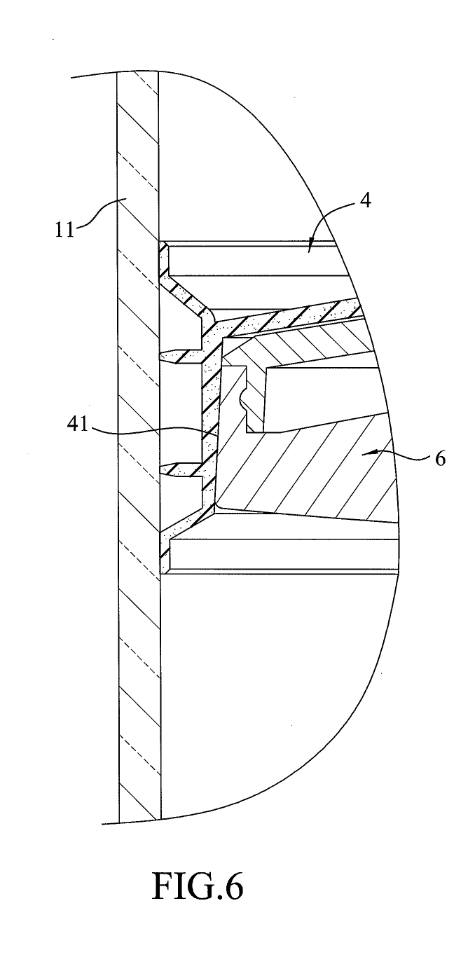

The accessible member 7 is mounted on the main body 31 of the mounting seat 3, is connected co-movably to the upper end 51 of the shaft 5, and includes a surrounding wall 72. The surrounding wall 72 rotatably encloses the main body 31 of the mounting seat 3, and has an inner surface 720. The inner surface 720 is formed with two guided protrusions 721, and an outer surface 310 of the main body 31 is formed with two guiding routes 311 extending spirally about the vertical axis (A). The guided protrusions 721 are diametrically opposite to each other, and slidably engage the guiding routes 311, respectively. By this way, when the accessible member 7 is rotated relative to the mounting seat 3, the guided protrusions 721 slide respectively in the guiding routes 311, and the accessible member 7 is moved relative to the mounting seat 3 in the axial direction. At the same time, the shaft 5 is moved together with the accessible member 7 along the vertical axis (A) so as to drive the valve 6 between a release position (see FIGS. 2 and 4) and an air-tight position (see FIGS. 5 and 6).

As shown in FIGS. 2 and 4, when the valve 6 is at the release position, the valve 6 is spaced apart from the sealing member 4 in the axial direction, and the sealing member 4 is radially spaced apart from the container 11. As shown in FIGS. 5 and 6, when the valve 6 is at the air-tight position, the valve 6 is received in the receiving space 41 to make the sealing member 4 resiliently deform and abut against the container 11 in an air-tight manner.

To use the blender, after disposing vegetables and/or fruits to be blended in the container 11, the mounting seat 3 is disposed at the unlocked position, and the insertion tube 32 of the mounting seat 3 is moved in the through hole 131 of the cap 13 together with the sealing member 4 to place the sealing member 4 at an appropriate height with respect to the container 11. The height of the sealing member 4 is related to a depth, to which the insertion tube 32 is inserted through the cap 13, and depends on the height of the vegetables and/or fruits disposed in the container 11. That is to say, the sealing member 4 mounted to the bottom end 30 of the extension tube 32 is to be placed in close proximity to the contents in the container 11, such that most of air in the container 11 may be discharged from the container 11 via the air holes 42 and a gap (see FIG. 4) between the sealing member 4 and the container 11. Then, the mounting seat 3 is rotated relative to the cap 13 from the unlocked position to the locked position, such that the second engaging mechanisms 322 engage respectively the first engaging mechanisms 134 to keep the mounting seat 3 at the desired position with respect to the cap 13. Subsequently, the accessible member 7 is rotated relative to the mounting set 3 to move the valve 6 from the release position to the air-tight position so as to seal the container 11 and to reduce the amount of air blended into the contents in the container 11.

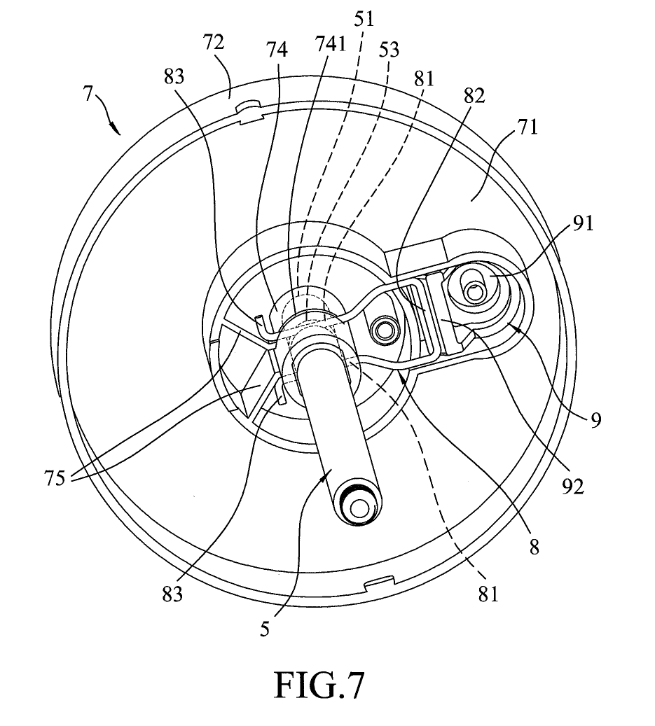

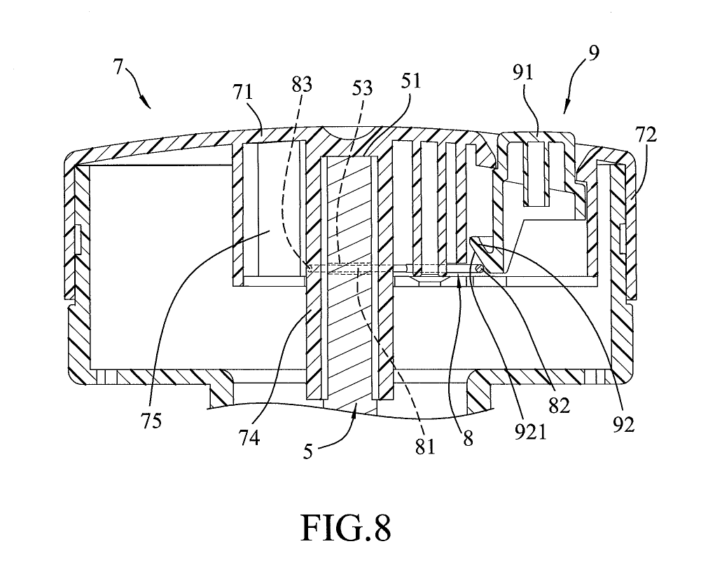

Further referring to FIGS. 7 and 8, the shaft 5 is detachably connected to the accessible member 7. In this embodiment, the shaft 5 is formed with a circular groove 53 adjacent to the upper end 51 thereof. The accessible member 7 further includes a top wall 71, a bushing 74 and two dividers 75. The top wall 71 is connected to the surrounding wall 72. The bushing 74 extends from the top wall 71 in the axial direction, surrounds the circular groove 53, and is formed with two diametrically opposite slits 741 corresponding in position to the circular groove 53 in the axial direction. The sealing module 2 further includes a clip 8 and a button 9. The clip 8 detachably snaps into the slits 741 and the circular groove 53 to interconnect the accessible member 7 and the shaft 5. The clip 8 includes a driven segment 82, two interlocking segments 81 extending respectively from opposite ends of the driven segment 82 and engaging the slits 741 and the circular groove 53, and two extending legs 83 respectively extending from the interlocking segments 81 away from each other. The dividers 75 of the accessible member 7 extend from the bushing 74 radially and outwardly at respective positions between the slits 741 away from the driven segment 82.

The button 9 is mounted on the top wall 71 of the accessible member 7, and includes a driving portion 91 and a tapered portion 92. The driving portion 91 is user-operable to move in the axial direction. The tapered portion 92 extends from the driving portion 91 toward the mounting seat 3, converges toward the mounting seat 3, and has an inclined surface 921. To detach the shaft 5 from the accessible member 7, the driving portion 91 is pushed by the user and to move toward the mounting seat 3, and the inclined surface 921 of the tapered portion 92 then abuts against and urges the driven segment 82 of the clip 8 to move toward the dividers 75, such that the extending legs 83 are separated by the dividers 75 and the interlocking segments 81 are detached from the slits 714 and the circular groove 53. By this way, the shaft 5 is detached from the bushing 74 of the accessible member 7.

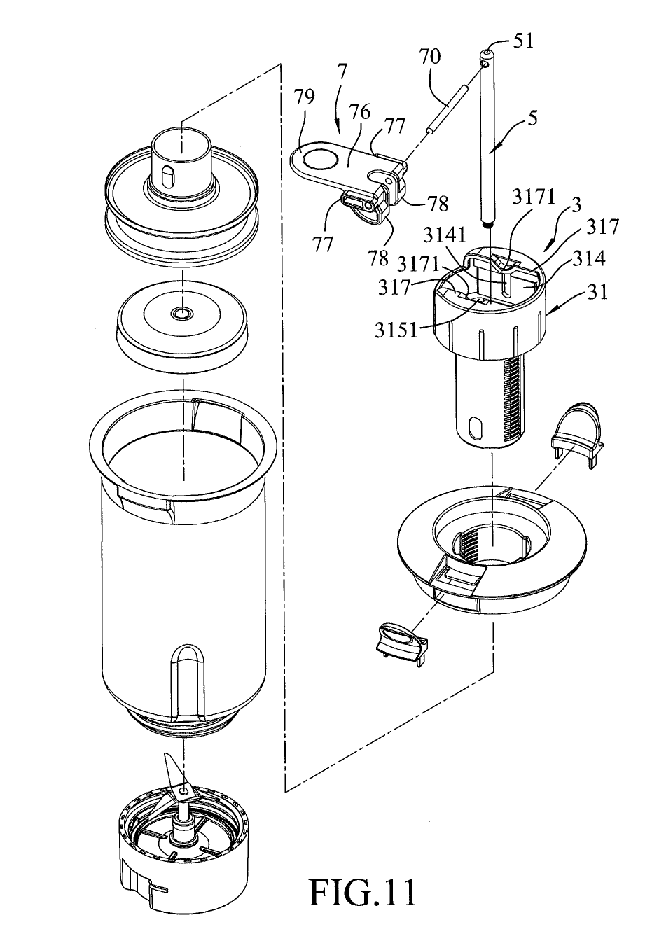

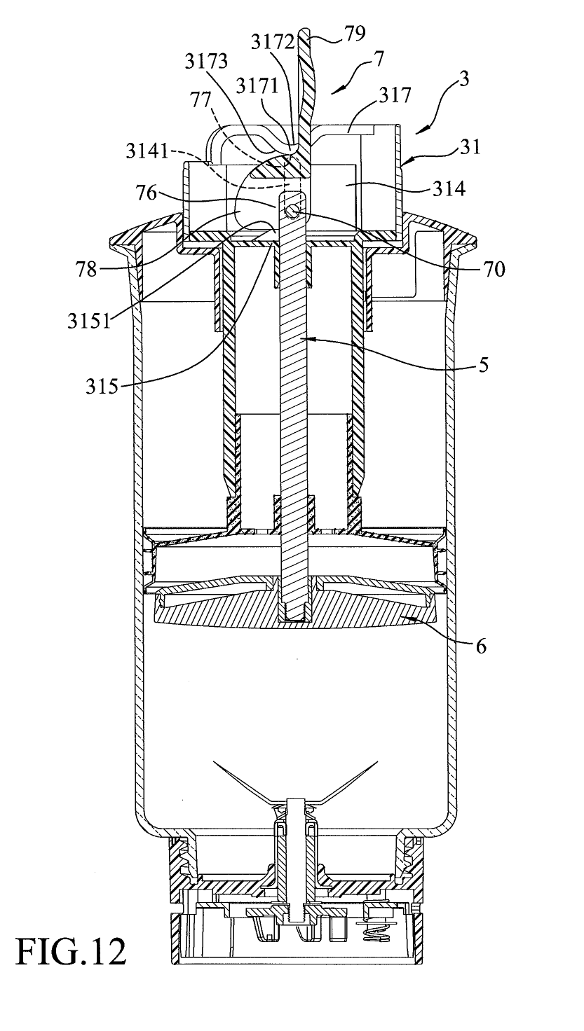

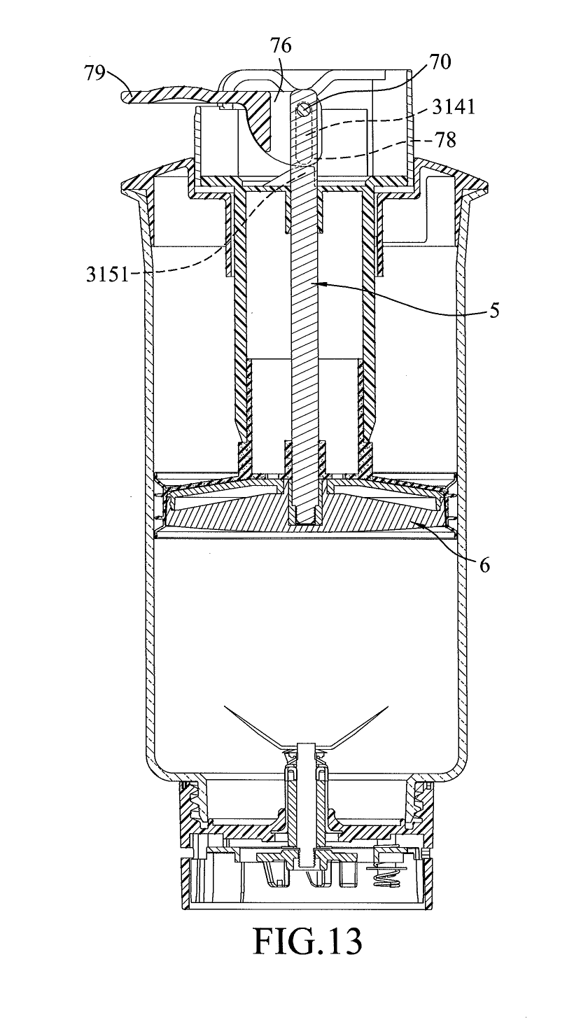

Referring to FIGS. 11 to 13, the second embodiment of the blender of the present invention is shown. The main difference between the second embodiment and the first embodiment resides in configurations of the accessible member 7 and the mounting seat 3. In this embodiment, the main body 31 of the mounting seat 3 includes two guiding walls 314 (only one can be seen in FIG. 11), two abutting walls 317, and a seated wall 315. Each of the guiding walls 314 is formed with a guiding slot 3141 extending in the axial direction. The abutting walls 317 are disposed respectively above the guiding walls 314, and each is formed with a depressed part 3171. The depressed part 3171 has an upper surface part 3172 that is depressed from an upper surface of the abutting wall 317, and a lower surface part 3173 that protrudes from a lower surface of the abutting wall 317 toward the guiding slot 3141. The seated wall 315 is seated on the cap 13, and is provided with a cam part 3151 that is raised therefrom and that protrudes upwardly away from the insertion tube 32.

The accessible member 7 includes a pivot pin 70, a base 76, a lever 79, two rounded ends 77, and two camming ends 78. The base 76 is disposed among the seated wall 315, the guiding walls 314 and the abutting walls 317 of the main body 31. The pivot pin 70 extends through the base 76 and the shaft 5 adjacent to the upper end 51 of the shaft 5 into the guiding slots 3141.

The lever 79 extends from the base 76 outwardly of the main body 31, and is operable to rotate the base 76 about the pivot pin 70 toward and away from the seated wall 315 and to drive the pivot pin 70 to move along the guiding slots 3141 in the axial direction as well as the shaft 5.

The rounded ends 77 protrude from the base 76, and are configured to abut respectively against the lower surface parts 3172 of the depressed parts 3171 so as to move the base 76 together with the pivot pin 70 toward the cam part 3151 when the lever 79 rotates the base 76 away from the seated wall 315. The camming ends 78 protrude from the base 76, and are configured to contact the cam part 3151 so as to raise the base 76 together with the pivot pin 70 away from the cam part 3151 when the lever 79 rotates the base 76 toward the seated wall 315 to thereby move the valve 6 from the release position to the air-tight position.

To sum up, the advantages of the blender of the present invention are as follows. By virtue of the cap 13 and the mounting seat 3, the height of the sealing member 4 with respect to the container 11 is adjustable according to the height of contents in the container 11 so as to dispel most of air in the container 11 outwardly from the container 11. Further, the valve 6 is capable of sealing the container 11 at the air-tight position. As a consequence, the amount of bubbles in the mixture processed by the blender may be reduced.

While the present invention has been described in connection with what are considered the most practical embodiments, it is understood that this invention is not limited to the disclosed embodiments but is intended to cover various arrangements included within the spirit and scope of the broadest interpretations and equivalent arrangements.

What is claimed is:

1. A blender comprising:
a container defining a vertical axis and having first and second open ends that are opposite to each other along the vertical axis;
a cap disposed to cover said first open end;
a motor unit including
a base seat that is disposed to seal said second open end, and
a blade that is rotatably mounted on said base seat and that extends into said container; and
a sealing module including
a mounting seat that is mounted on said cap and that is adjustable to move along the vertical axis with respect to said cap,
a sealing member that is disposed in said container, that is mounted to a bottom end of said mounting seat, and that defines a receiving space opposite to said mounting seat,
a shaft that extends through and movable relative to said mounting seat, said cap and said sealing member along the vertical axis, and that has opposite upper and lower ends,
a valve that is mounted co-movably to said lower end of said shaft, and
an accessible member that is mounted on said mounting seat, connected co-movably to said upper end of said shaft, and operable to move said shaft along the vertical axis so as to drive said valve between a release position, where said valve is spaced apart from said sealing member in an axial direction parallel to the vertical axis and said sealing member is radially spaced apart from said container, and an air-tight position, where said valve is received in said receiving space to make said sealing member resiliently deform and abut against said container in an air-tight manner.

2. The blender as claimed in claim 1, wherein the sealing member is made of a resilient material.

3. The blender as claimed in claim 1, wherein:
said cap is formed with a through hole extending in the axial direction, and has an inner surface defining said through hole and provided with at least one first engaging mechanism; and
said mounting seat includes an insertion tube movably extending through said through hole and having an outer surface that is provided with at least one second engaging mechanism for engaging said first engaging mechanism to position said mounting seat with respect to said cap.

4. The blender as claimed in claim 3, wherein:
said inner surface of said cap is formed with at least one guiding groove extending in the axial direction and depressed radially from said inner surface;
said second engaging mechanism protrudes radially and outwardly from said outer surface of said insertion tube;
said mounting seat is rotatable about the vertical axis with respect to said cap between an unlocked position, where said mounting seat is movable along the vertical axis with respect to said cap and said second engaging mechanism is slidable in said guiding groove, and a locked position, where said second engaging mechanism engages said first engaging mechanism so as to maintain said mounting seat at a desired position with respect to said cap.

5. The blender as claimed in claim 4, wherein said first engaging mechanism includes a plurality of furrows that are depressed radially from said inner surface of said cap and that are spaced apart from one another in the axial direction, and said second engaging mechanism includes a plurality of ribs that protrude radially and outwardly from said outer surface of said insertion tube and that are spaced apart from one another in the axial direction.

6. The blender as claimed in claim 5, wherein said guiding groove is defined by a first terminating end surface that extends in the axial direction and that is disposed adjacent to said first engaging mechanism, and a second terminating end surface that extends in the axial direction and that is angularly opposite to said first terminating end surface about the vertical axis, and
wherein said outer surface of said insertion tube is further provided with a barrier ridge that extends in the axial direction, that protrudes radially and outwardly from said outer surface, that is disposed adjacent to said second engaging mechanism, and that abuts against said first and second terminating end surfaces when said mounting seat is disposed at the locked and unlocked positions, respectively.

7. The blender as claimed in claim 6, wherein a protruding thickness of said barrier ridge is larger than that of said ribs of said second engaging mechanism and a depressed depth of said furrows of said first engaging mechanism, and is smaller than a depressed depth of said guiding groove.

8. The blender as claimed in claim 6, wherein said inner surface of said cap is further provided with a protuberance that is disposed in said guiding groove between said first and second terminating end surfaces and that provides a restricting force to said barrier ridge of said insertion tube so as to prevent said mounting seat from rotating between the unlocked and locked positions when an external force is not applied.

9. The blender as claimed in claim 3, wherein one of said first and second engaging mechanisms includes a plurality of furrows that are spaced apart from one another in the axial direction, and the other one of said first and second engaging mechanisms includes a plurality of ribs that are spaced apart from one another in the axial direction and that detachably engage at least some of said furrows so as to maintain said mounting seat at the desired position with respect to said cap.

10. The blender as claimed in claim 1, wherein said mounting seat defines a passage extending in the axial direction, said shaft extends through said passage, and said sealing member is formed with at least one air hole spatially communicating said receiving space with said passage.

11. The blender as claimed in claim 10, wherein said cap is formed with a through hole extending in the axial direction, and
wherein said mounting seat includes a main body seated on said cap, and an insertion tube extending from said main body in the axial direction through said through hole and having said bottom end, said passage extending through said main body and said insertion tube.

12. The blender as claimed in claim 11, wherein said main body of said mounting seat has an outer surface, and said accessible member includes a surrounding wall rotatably enclosing said main body of said mounting seat and having an inner surface, one of said outer surface of said main body and said inner surface of said surrounding wall being formed with at least one guiding route that extends spirally about the vertical axis, and the other one of said outer surface and said inner surface being formed with at least one guided protrusion that slidably engages said guiding route such that said accessible member is moved relative to said mounting seat in the axial direction when said accessible member is rotated relative to said mounting seat.

13. The blender as claimed in claim 12, wherein said shaft is formed with a circular groove adjacent to said upper end,
wherein said accessible member further includes a top wall connected to said surrounding wall, and a bushing extending from said top wall in the axial direction, surrounding said circular groove, and formed with two diametrically opposite slits that correspond in position to said circular groove in the axial direction, and
wherein said sealing module further includes a clip detachably snapping into said slits and said circular groove to interconnect said accessible member and said shaft.

14. The blender as claimed in claim 13, wherein said clip includes a driven segment having two opposite ends, two interlocking segments extending respectively from said opposite ends of said driven segment and engaging said slits and said circular groove, and two extending legs respectively extending from said interlocking segments away from each other.

15. The blender as claimed in claim 14, wherein:
said accessible member further includes two dividers extending from said bushing radially and outwardly at positions between said slits away from said driven segment;
said sealing module further includes a button mounted on said accessible member and including a driving portion that is user-operable to move in the axial direction, and a tapered portion that extends from said driving portion toward said mounting seat, that converges toward said mounting seat, and that has an inclined surface; and
when said driving portion is pushed and moved toward said mounting seat, said inclined surface of said tapered portion abuts against and urges said driven segment of said clip to move toward said divider such that said extending legs are separated by said dividers and said interlocking segments are detached from said slits and said circular groove.

16. The blender as claimed in claim 11, wherein:
said main body of said mounting seat includes
a guiding wall formed with a guiding slot extending in the axial direction,
an abutting wall disposed above said guiding wall and formed with a depressed part that is depressed therefrom toward said guiding slot, and
a seated wall seated on said cap and provided with a cam part that is raised therefrom and that protrudes upwardly away from said insertion tube; and
said accessible member includes
a base disposed among said seated wall, said guiding wall and said abutting wall of said main body,
a pivot pin extending through said base and said shaft adjacent to said upper end of said shaft into said guiding slot,
a lever extending from said base outwardly of said main body and operable to rotate said base about said pivot pin toward and away from said seated wall and to drive said pivot pin to move in said guiding slot in the axial direction,
a rounded end protruding from said base, and configured to abut against said depressed part of said abutting wall so as to move said base together with said pivot pin toward said cam part when said lever rotates said base away from said seated wall, and
a camming end protruding from said base, and configured to contact said cam part so as to raise said base together with said pivot pin away from said cam part when said lever rotates said base toward said seated wall.
